(19) United States
(12) Patent Application Publication
(10) Pub. No.: US 2016/0145482 A1
(43) Pub. Date: May 26, 2016

(54) COMPOSITIONS FOR TREATING SUBTERRANEAN FORMATIONS

(71) Applicant: HALLIBURTON ENERGY SERVICES, INC., Houston, TX (US)

(72) Inventor: Baireddy Raghava Reddy, The Woodlands, TX (US)

(73) Assignee: Halliburton Energy Services, Inc., Houston, TX (US)

(21) Appl. No.: 14/785,761

(22) PCT Filed: Sep. 13, 2013
(86) PCT No.: PCT/US2013/059728

§ 371 Date: Oct. 20, 2015

(51) Int. Cl. C09K 8/035; E21B 43/16; C09K 8/72; C09K 8/42; C09K 8/62

(52) U.S. Cl. CPC C09K 8/035; C09K 8/42; C09K 8/62; C09K 8/725; E21B 43/16; C09K 2208/02

(57) ABSTRACT

A method comprises obtaining or providing a treatment fluid comprising a gellable agent comprising at least two primary amino groups, and a crosslinking agent comprising genipin, its conjugates, derivatives, analogs, or combinations thereof and placing the treatment fluid in a subterranean formation. The method may further comprise crosslinking the gellable agent with the crosslinking agent.

### BACKGROUND OF THE INVENTION

During the drilling, completion, and production phases of wells for petroleum, the downhole use of compositions having high viscosities, including gels, is important for a wide variety of purposes. Higher viscosity fluids can more effectively carry materials (e.g., proppants) to a desired location downhole. Similarly, higher viscosity drilling fluids can more effectively carry materials away from a drilling location downhole. Further, the use of higher viscosity fluids during hydraulic fracturing generally results in larger, more dominant fractures. Further still, viscosified fluids also find use in applications that require control of fluid flow into or out of wellbore or the subterranean formation. For example, at some point in the life of a well, it may be desirable to mitigate the flow of fluids through a portion of a subterranean formation that is penetrated by a well. In some instances, it may be desirable to control the flow of fluids introduced into the well so that the flow of the fluid into high-permeability portions of the formation is mitigated. For example, in an injection well, it may be desirable to seal off high-permeability portions of a subterranean formation that would otherwise accept most of an injected treatment fluid. By sealing off the high-permeability portions of the subterranean formation, the injected treatment fluid may thus penetrate less permeable portions of the subterranean formation. In an analogous manner, in some instances, it may be desirable to stop flow of unwanted fluids (for example, water or gas) from formation into a wellbore.

Higher viscosity fluids are sometimes prepared using gellable agents that form the higher viscosity fluids upon the addition of a crosslinking agent. Sometimes the crosslinking agent may be a compound having an appreciable water solubility and toxicity, such that it could have a deleterious effect if ingested by organisms (e.g., humans) upon unintended exposure to such compounds.

### SUMMARY OF THE INVENTION

Because of the potential toxicity of crosslinking agents and gellable agents, it would be desirable to use crosslinking agents and/or gellable agents that have lower or negligible toxic potential and, at the same time, provide fluids that are suitable higher viscosity treatment fluids.

In various embodiments, the invention relates to a method comprising: obtaining or providing a treatment fluid comprising a gellable agent comprising at least two primary amino groups, and a crosslinking agent comprising genipin, its conjugates, derivatives, analogs, or combinations thereof; and placing the treatment fluid in a subterranean formation.

In various other embodiments, the invention relates to a composition comprising: a gellable agent comprising partially hydrolyzed polyvinylformamide, chitosan or combinations thereof; and a crosslinking agent represented by Structure VII:

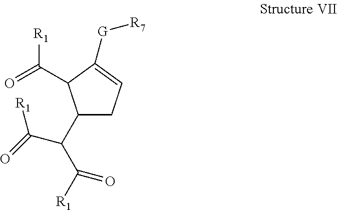

wherein:
G represents an alkyl, alkenyl, cycloalkyl, heterocyclyl or an aryl group;
each R₁ is, independently, hydrogen, —OR₂, —NR₃R₄ or a halogen, wherein each R₂, R₃, and R₄ are, independently, hydrogen, alkyl, cycloalkyl, cycloalkylalkyl, aryl, arylalkyl or an R₃ and an R₄, together with the nitrogen atom to which they are attached, form a heterocyclyl group; and
R₇ represents —OR₆, wherein R₆ is hydrogen or alkyl.

In still other embodiments, the invention relates to a system comprising: a treatment fluid comprising a gellable agent comprising at least two primary amino groups, and a crosslinking agent comprising genipin, its conjugates, derivatives, analogs, or combinations thereof; and a subterranean formation comprising the treatment fluid.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “downhole” as used herein refers to under the surface of the earth, such as a location within or fluidly connected to a wellbore.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean material can be any section of a wellbore and any section of an underground formation in fluid contact with the wellbore, including any materials placed into the wellbore such as cement, drill shafts, liners, tubing, or screens. In some examples, a subterranean material can be any below-ground area that can produce liquid or gaseous petroleum materials, water, or any section below-ground in fluid contact therewith.

Embodiments of the present invention relate to treatment fluids. More specifically, embodiments of the present invention relate to treatment fluids comprising, among other things, a gellable agent comprising at least two primary amino groups, and a crosslinking agent comprising genipin, its conjugates, derivatives, analogs, or combinations thereof, and methods of using the treatment fluids in subterranean formations penetrated by well bores. As used herein, the term “conjugates” refers broadly to compounds resulting from covalently linking a biological molecule (e.g., a saccharide such as glucose) with another biological (e.g., genipin) or synthetic molecule. As used herein, the term “derivatives” refers broadly to compounds obtained by replacement at least hydrogen by another functional group.

As used herein, the term “treatment fluids” refers generally to any fluid that may be used in a subterranean application in conjunction with a desired function and/or for a desired purpose. The term “treatment fluid” does not imply any particular action by the fluid or any component thereof. As a result, the present compositions can be inexpensive and simple to prepare, using either batch mixing or on-the-fly procedures. In some embodiments, the term “treatment fluids” includes, but is not limited to drilling fluids, stimulation fluids, clean-up fluids, fracturing fluids, spotting fluids, production fluids, completion fluids, remedial treatment fluids, abandonment fluids, acidizing fluids, cementing fluids, fluid control materials (e.g., water control materials), packing fluids or combinations thereof.

As used herein, the term “drilling fluid” refers to fluids, slurries, or muds used in drilling operations downhole, such as the formation of a wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations and can be any fluid designed for localized treatment of a downhole region. In one example, a spotting fluid can include a lost circulation material for treatment of a specific section of a wellbore, such as to seal off fractures in a wellbore and prevent sag. In another example, a spotting fluid can include a water control material. In some examples, a spotting fluid can be designed to free a stuck piece of drilling or extraction equipment; can reduce torque and drag with drilling lubricants; prevent differential sticking; promote wellbore stability; and can help to control mud weight.

As used herein, the term “production fluid” refers to fluids or slurries used downhole during the production phase of a well. Production fluids can include downhole treatments designed to maintain or increase the production rate of a well, such as perforation treatments, clean-up treatments or remedial treatments.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments downhole. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material, such as a polymer, that is in an at least partially uncured state.

As used herein, the term “fluid control material” (e.g., a “water control material”) refers to a solid or liquid material that, by virtue of its viscosification in the flowpaths producing a fluid (e.g., water) alters, reduces or blocks the flow rates of such fluids into the wellbore, such that hydrophobic material can more easily travel to the surface and such that hydrophilic material (including water) can less easily travel to the surface. For example, a fluid control material can be used to treat a well to cause a proportion of a fluid produced, which may include water, to decrease and to cause the proportion of hydrocarbons produced to increase, such as by selectively causing the material to form a viscous plug between water-producing subterranean formations and the wellbore, while still allowing hydrocarbon-producing formations to maintain output.

In some embodiments, the fluid control material mitigates (e.g., reduces, stops or diverts) the flow of fluids (e.g., treatment fluids) through a portion of a subterranean formation that is penetrated by the well such that the flow of the fluid into high-permeability portions of the formation is mitigated. For example, in an injection well, it may be desirable to seal off high-permeability portions of a subterranean formation that would otherwise accept most of an injected treatment fluid. By sealing off the high-permeability portions of the subterranean formation, the injected treatment fluid may thus penetrate less permeable portions of the subterranean formation. In other embodiments, the fluid control material helps mitigate the production of undesired fluids (e.g., water) from a well by at least sealing off one or more permeable portions of a treated subterranean formation.

As used herein, the term “packing fluid” refers to fluids or slurries that can be placed in the annular region of a well, between tubing and outer casing above a packer. In various examples, the packer fluid can provide hydrostatic pressure in order to lower differential pressure across a sealing element; lower differential pressure on the wellbore and casing to prevent collapse; and protect metals and elastomers from corrosion.

In general, the treatment fluids of the present invention comprise, among other things, a gellable agent comprising at least two primary amino groups, and a crosslinking agent comprising genipin, its conjugates, derivatives, analogs, or combinations thereof. In an embodiment, the treatment fluid is used as a fracturing fluid. In other embodiments, the compositions and methods of the present invention may be useful to alter, block, and/or control the flow of fluids into or out of subterranean formations. Moreover, the compositions of the present invention may possess desirable environmental properties for performing such operations. The crosslinking agent acts to crosslink at least two molecules of the gellable agent comprising at least two primary amino groups.

In some embodiments, the compositions of the present invention generally comprise, among other things, a gellable agent comprising at least two primary amino groups that can react, under appropriate conditions (e.g., time, temperature, pH, etc.) with the crosslinking agent comprising genipin, its conjugates, derivatives, analogs, or combinations thereof, to form a crosslinked gel. In some embodiments, certain additives (e.g., a gelation-retarding additive) may be added in the compositions of the present invention to delay or further delay the crosslinking reaction between the gellable agent and the crosslinking agent so that the compositions may be used in a wider range of applications than would be otherwise possible, e.g., fluid control applications (e.g., water control applications). In some embodiments, however, the compositions of the present invention do not require the addition of additives that delay or further delay the crosslinking reaction between the gellable agent and the crosslinking agent because the compositions already have gelation times (i.e., the time required for the compositions of the embodiments of the present invention to form a crosslinked gel) suitable for, e.g., fluid control applications (e.g., water control applications).

The gelation time required for the compositions of the embodiments of the present invention can vary widely. This length of time may vary, depending on a number of factors, including the type of crosslinking agent used, the type of gellable agent used, the type of aqueous fluid used, concentrations of components used, the pH, the temperature, and a variety of other factors. Delaying the gelation of a composition may be desirable to allow, among other things, pumping of the composition to its desired location. The desired gelation time varies depending on the specific application. For instance, for wells of considerable depth or increased temperature, a longer gelation time may be required to deliver the composition to its desired destination before the composition forms the crosslinked gel.

As used herein, the term “crosslinking agent,” refers to any suitable crosslinking agent that is capable of crosslinking two or more molecules of gellable agent comprising at least two primary amino groups, or “gellable agent” for short. In one embodiment, the crosslinking agent comprising at least two reactive groups (e.g., carbonyl groups), wherein at least one of the reactive groups present on the crosslinking agent reacts with a primary amine group present on a first molecule of gellable agent and at least one other reactive group present on the crosslinking agent reacts with a primary amine group present on a second molecule of gellable agent. In short, in one embodiment, a crosslinking agent crosslinks at least two molecules of gellable agent in an intermolecular fashion. It should be understood, however, that crosslinking agents can also crosslink one molecule of gellable agent intramolecularly. It should also be understood that, in some instances, depending on the number of reactive groups present on the crosslinking agent, the crosslinking agent could crosslink more than two molecules of gellable agent intermolecularly, indeed as many as steric hindrance will allow; or crosslink a first and a second molecule of gellable agent intermolecularly and crosslink the first or the second molecule of gellable agent intramolecularly. Ultimately, those of skill in the art will be able to determine the degree of intermolecular and/or intramolecular crosslinking necessary for the treatment fluids of the present invention to be suitable for use as, e.g., higher viscosity treatment fluids.

The crosslinking agents may be provided or used in any suitable form. For instance, the crosslinking agents may be used in any form, for example as an aqueous solution, a gel, an emulsion, a suspension, or as a solid. In some embodiments, a crosslinking agent may be dissolved, suspended, or emulsified in a liquid.

In some embodiments, genipin (Structure I) may be used in its naturally-occurring conjugate form, namely, geniposde (Structure II):

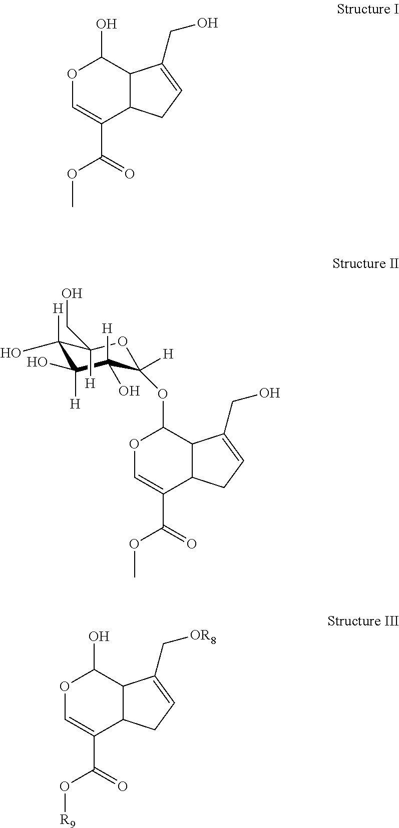

In still other embodiments, genipin may be employed in its derivative form, shown in Structure III, wherein R₈ and R₉ may be independently hydrogen or an alkyl, cycloalkyl, heterocycloalkyl, alkenyl, an aryl or an acyl group.

Those of ordinary skill in the art will recognize that the compounds of Structures I-III have three chiral centers. All diastereomers of the compounds of Structures I-III are contemplated herein. In some embodiments, the following diastereomers of Structures IA-IIIA are preferred:

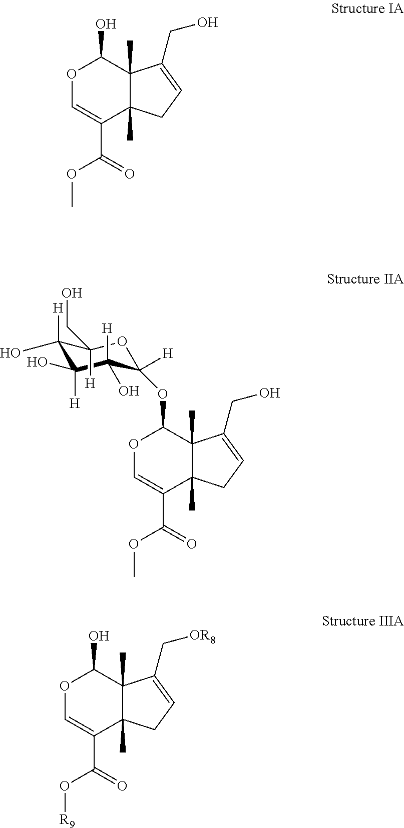

As used herein, the term “aryl” broadly refers to cyclic aromatic hydrocarbons that do not contain heteroatoms in the ring. Such aryl groups may be substituted or unsubstituted. Aryl groups include, but are not limited to, phenyl, azulenyl, heptalenyl, biphenyl, indacenyl, fluorenyl, phenanthrenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative, non-limiting substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

As used herein, the term “heterocyclyl” broadly refers to aromatic and non-aromatic ring groups containing 3 or more ring members, of which, one or more is a heteroatom such as, but not limited to, N, O, and S. Thus a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a Ca-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms sums up to equal the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups, such as cycloalkyl groups. Representative heterocyclyl groups include, but are not limited to, oxiranyl, aziridinyl, oxetanyl, azetidinyl, furanyl, pyrrolyl, indolyl, imidazolyl, pyrazolyl, indazolyl, tetrazolyl, 2H-pyranyl, pyridinyl, quinolinyl, piperidinyl, pyrazinyl, morpholinyl, oxepinyl, diazepinyl, and the like.

As used herein, the term “alkyl” broadly refers to straight chain and branched alkyl groups having from 1 to 40 carbon atoms, 1 to about 20 carbon atoms, 1 to 12 carbons or, in some embodiments, from 1 to 8 carbon atoms or 1 to 4 carbon atoms. Such alkyl groups may be substituted or unsubstituted. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. The term “alkyl” also encompasses groups including —(CH₂)ₙ— groups.

As used herein, the term “alkenyl” broadly refers to straight and branched chain alkyl groups as defined herein, except that at least one double bond exists between two carbon atoms. Such alkenyl groups may be substituted or unsubstituted. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, hexadienyl, and the like.

As used herein, the term “aralkyl” broadly refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl group are alkenyl groups as defined herein in which a hydrogen or carbon bond of an alkenyl group is replaced with a bond to an aryl group as defined herein. A representative aralkenyl group is a styryl group.

As used herein, the term “cycloalkyl” broadly refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Such cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The cycloalkyl group may have one more unsaturated bonds.

As used herein, the term “heterocyclylalkyl” broadly refers to alkyl groups as defined herein in which a hydrogen or carbon bond of an alkyl group is replaced with a bond to a heterocyclyl group as defined herein.

As used herein, the term “substituted” broadly refers to a group (e.g., an aryl group, a heterocycyl group, an alkyl group, an alkenyl group, a cycloalkyl) in which one or more hydrogen atoms contained therein are replaced by one or more “functional groups” or “substituents.” Examples of substituents or functional groups include, but are not limited to, halogen (e.g., F, Cl, Br, and I); an oxygen atom in groups such as hydroxyl groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents include F, Cl, Br, I, OR, OC(O)N(R′)₂, CN, NO, NO₂, ONO₂, azido, CF₃, OCF₃, R′, ═O (oxo), ═S (thiono), C(O), S(O), methylenedioxy, ethylenedioxy, N(R)₂, SR, SOR, SO₂R′, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen or a carbon-based moiety, and wherein the carbon-based moiety can itself be further substituted; for example, wherein R can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or wherein two R groups bonded to a nitrogen atom or to adjacent nitrogen atoms can together with the nitrogen atom or atoms form a heterocyclyl.

As used herein, the term “acyl” broadly refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. Where the carbonyl carbon atom is bonded to a hydrogen, the group is a “formyl” group. Where the carbonyl carbon atom is bonded to a halogen atom, the group is a “haloacyl” group. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms (e.g., nitrogen and oxygen). A nicotinoyl group (pyridyl-3-carbonyl) group is an example of an acyl group within the meaning herein. Other examples include acetyl, benzoyl, phenylacetyl, pyridylacetyl, cinnamoyl, and acryloyl groups and the like.

As used herein, the terms “halo” or “halogen” or “halide,” by themselves or as part of another substituent, mean, unless otherwise stated, a fluorine, chlorine, bromine, or iodine atom, preferably, fluorine, chlorine, or bromine.

As used herein, the term “amino group” broadly refers to a substituent of the form —NH₂, —NHR₁₀, —N(R₁₀)₂, —N(R₁₀)₃⁺, wherein each R₁₀ is independently selected, and protonated forms of each, except for —N(R₁₀)₃⁺, which cannot be protonated; or to the group —N(R₁₀)— and protonated forms thereof. Accordingly, any compound substituted with an amino group can be viewed as an amine. An “amino group” within the meaning herein can be a primary, secondary, tertiary or quaternary amino group, preferably a primary or a secondary amino group.

Those of skill in the art will recognize that genipin is capable of forming the ring-open form of genipin to form Structure IV by ring opening of the hemi-acetal structure of genipin.

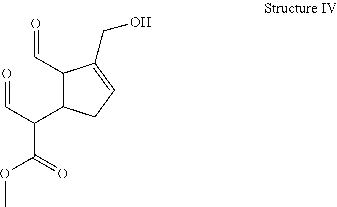 [SMILES: COC(=O)C(C=O)C1CC=C(CO)C1C=O]

Those of ordinary skill in the art will recognize that the compound of Structure IV has three chiral centers. All diastereomers of the compound of Structures IV are contemplated herein.

In some embodiments, the crosslinking agent is an analog of the open cyclic form of genipin shown in Structure IV and is represented by Structure V.

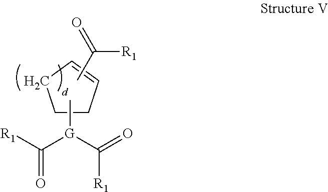

wherein G represents an alkyl, alkenyl, cycloalkyl, heterocyclyl or an aryl group; each R₁ is, independently, hydrogen, —OR₂, —NR₃R₄ or halo, wherein each R₂, R₃, and R₄ are, independently, hydrogen, alkyl, cycloalkyl, cycloalkylalkyl, aryl, arylalkyl or an R₃ and an R₄, together with the nitrogen atom to which they are attached, form a heterocyclyl group; the dashed bond represents an optional double bond; and the subscript d is an integer from 1 to 3. In some embodiments, the cycloalkyl ring optionally comprising at least one double bond may be fused with a cycloalkyl, heterocyclyl or an aryl group. In some embodiments, G represents an alkyl group, preferably an alkyl group comprising 1 to 8 carbon atoms. In some embodiments, in compounds of the Structure V, at least one R₁ is hydrogen. In some embodiments, two R₁ groups are hydrogen and one R₁ group is hydrogen, —OR₂, —NR₃R₄ or halo, wherein R₂, R₃, and R₄ are defined herein. In some embodiments, in compounds of the Structure V, one R₁ group is hydrogen and the other two R₁ groups are independently hydrogen, —OR₂, —NR₃R₄ or halo, wherein R₂, R₃, and R₄ are defined herein. In some embodiments, in compounds of the Structure V, two R₁ groups are hydrogen and the other R₁ group is —OR₂, wherein R₂ is defined herein. In some embodiments, R₂ is alkyl, preferably methyl. In some embodiments, one or more carbon atoms not bearing a C(O)R₁ group or G may be optionally substituted. As used herein, the term “analog” broadly refers to a compound that is similar in structure to another compound.

Those of ordinary skill in the art will recognize that the compound of Structure V has at least two chiral centers. All diastereomers of the compound of Structures V are contemplated herein.

In other embodiments, the crosslinking agent is an analog of the open cyclic form of genipin shown in Structure IV and is represented by Structure VI:

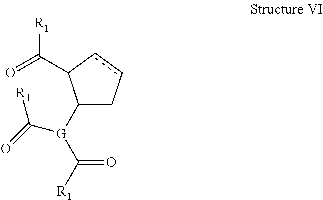

wherein G represents an alkyl, alkenyl, cycloalkyl, heterocyclyl or an aryl group; each R₁ is, independently, hydrogen, —OR₂, —NR₃R₄ or halo, wherein R₂, R₃, and R₄ are defined herein; and the dashed bond represents an optional double bond. In some embodiments, G represents an alkyl group, preferably an alkyl group comprising 1 to 8 carbon atoms. In some embodiments, in compounds of the Structure VI, at least one R₁ is hydrogen. In some embodiments, two R₁ groups are hydrogen and one R₁ group is hydrogen, —OR₂, —NR₃R₄ or halo, wherein R₂, R₃, and R₄ are defined herein. In some embodiments, in compounds of the Structure VI, one R₁ group is hydrogen and the other two R₁ groups are independently hydrogen, —OR₂, —NR₃R₄ or halo, wherein R₂, R₃, and R₄ are defined herein. In some embodiments, in compounds of the Structure VI, two R₁ groups are hydrogen and the other R₁ group is —OR₂, wherein R₂ is defined herein. In some embodiments, R₂ is alkyl, preferably methyl. In some embodiments, one or more carbon atoms not bearing a C(O)R₁ group or G-(C(O)R₁)₂ may be optionally substituted. When one or more carbon atoms not bearing a C(O)R₁ group or a G-(C(O)R₁)₂ group are substituted, they may be substituted with one or more groups -G′-R₅, wherein each G′ independently represents an alkyl, alkenyl, cycloalkyl, heterocyclyl or an aryl group and each R₅ independently represents hydrogen, —OR₆ or —NR₃R₄, wherein R₃ and R₄ are defined herein and R₆ is hydrogen or alkyl. In some embodiments, in the group -G′-R₅, each G′ independently represents an alkyl group, preferably an alkyl group comprising 1 to 8 carbon atoms. In some embodiments, each G′ independently represents an alkyl group comprising 1 to 4 carbon atoms. In some embodiments, in the group G′-R₅, each G′ independently represents an alkyl group comprising 1 to 4 carbon atoms and each R₅ independently represents —OR₆, wherein R₆ is hydrogen or alkyl, preferably hydrogen.

Those of ordinary skill in the art will recognize that the compound of Structure VI has at least two chiral centers. All diastereomers of the compound of Structures VI are contemplated herein.

In other embodiments, the crosslinking agent is an analog of the open cyclic form of genipin shown in Structure IV and is represented by Structure VII:

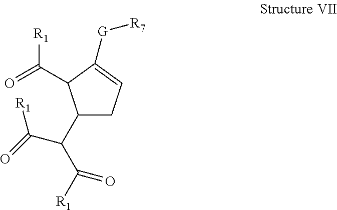

wherein G represents an alkyl, alkenyl, cycloalkyl, heterocyclyl or an aryl group; each R₁ is, independently, hydrogen, —OR₂, —NR₃R₄ or halo, wherein R₂, R₃, and R₄ are defined herein; and R₇ represents —OR₆, wherein R₆ is hydrogen or alkyl. In some embodiments, G represents an alkyl group, preferably an alkyl group comprising 1 to 8 carbon atoms, and most preferably an alkyl group comprising 1 to 4 carbon atoms. In some embodiments, in compounds of the Structure VII, at least one R₁ is hydrogen. In some embodiments, two R₁ groups are hydrogen and one R₁ group is hydrogen, —OR₂, —NR₃R₄ or halo, wherein R₂, R₃, and R₄ are defined herein. In some embodiments, in compounds of the Structure VII, one R₁ group is hydrogen and the other two R₁ groups are independently hydrogen, —OR₂, —NR₃R₄ or halo, wherein R₂, R₃, and R₄ are defined herein. In some embodiments, in compounds of the Structure VII, two R₁ groups are hydrogen and the other R₁ group is —OR₂, wherein R₂ is defined herein. In some embodiments, R₂ is alkyl, preferably methyl. In some embodiments, G represents an alkyl group comprising 1 to 4 carbon atoms and R₇ represents —OR₆, wherein R₆ is hydrogen or alkyl, preferably hydrogen.

Those of ordinary skill in the art will recognize that the compound of Structure VII has at least two chiral centers. All diastereomers of the compound of Structures VII are contemplated herein.

In other embodiments, the crosslinking agent is an analog of the open cyclic form of genipin shown in Structure IV and is represented by Structure VIII:

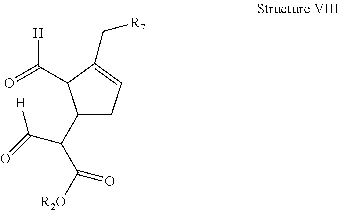

wherein R₂ is alkyl, preferably methyl and R₇ represents —OR₆, wherein R₆ is hydrogen or alkyl, preferably hydrogen. When R₂ represents methyl and R₇ represents OH, the compound is the open cyclic form of genipin.

Those of ordinary skill in the art will recognize that the compound of Structure VIII has at least three chiral centers. All diastereomers of the compound of Structures VIII are contemplated herein.

As used herein, “gellable agent comprising at least two primary groups,” or “gellable agent” for short, refers broadly to any suitable gellable agent comprising at least two primary amino groups that can react with the reactive groups of the crosslinking agents described herein. Representative “gellable agent comprising at least two primary amino groups” include, but are not limited to, partially or fully hydrolyzed polyvinyl formamide (PVF), any polysaccharide comprising at least to amine groups (e.g., chitosan), polyethylene imine, polylysine, poly(vinyl alcohol-vinylamine), and combinations thereof.

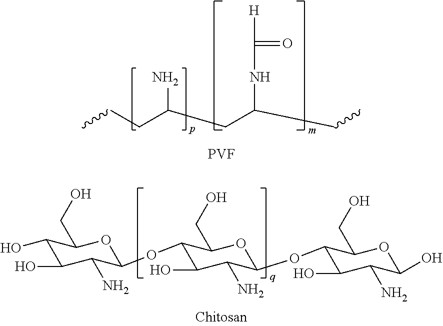

In the structure given above for partially hydrolyzed PVF, the subscript p is an integer from 100 to 10,000 (e.g., from 100 to 5,000, from 1,000 to 6,000, from 2,500 to 8,000 or about 5,000 to 10,000) and the subscript m is an integer from 100 to 10,000 (e.g., from 100 to 5,000, from 1,000 to 6,000, from 2,500 to 8,000 or about 5,000 to 10,000). In the structure given above for chitosan, the subscript q is an integer from 1,500 to 25,000 (e.g., from 1,500 to 5,000, from 5,000 to 10,000, from 5,000 to 15,000 or about 5,000 to 20,000).

In some embodiments, the PVF is partially, substantially or fully hydrolyzed. For example, the PFV may be 5-90% hydrolyzed, e.g., 10-50% hydrolyzed, 20-40% hydrolyzed, 40-80% hydrolyzed, 40-60% hydrolyzed or 30-50% hydrolyzed. A fully hydrolyzed polyvinylformamide may be referred to as polyvinylamine. Other analogous polymers such as partially hydrolyzed polyvinylacetamide containing the vinylamine groups generated by hydrolysis of the amide functional groups are also envisioned to be within the scope of this invention.

In some embodiments, the treatment fluids of the present invention, after the completion of crosslinking reactions, have a viscosity that is sufficiently high for them to be used as treatment fluids, including fluid control materials (e.g., water control materials) or fracturing fluids. In other embodiments, the treatment fluids of the present invention, after the completion of crosslinking reactions, have a viscosity that is sufficiently high for them to be used in applications that require suspension of particulates; in fluid displacement applications (e.g., polymer flooding applications for enhanced oil recovery) or sealing applications).

As used herein, the term “sufficiently high,” as it refers to viscosity, is a viscosity ranging from about 400 cP to about 4,000,000 cP (e.g., from about 500 cP to about 3,000,000 cP or from about 1,000 cP to about 1,000,000 cP) at a temperature from about 80° F. to about 180° F.

Upon reaction of the crosslinking agent with the gellable agent comprising at least two primary amino groups, the gellable agent forms a crosslinked gel within about 5 minutes to about 10 hours, e.g., within about 4 to about 10 hours, within about 5 to about 9 hours, or within about 6 to about 9 hours.

Without being limited by theory, it is believed that crosslinking reactions take place by reactions of primary amine groups of the gellable agent, at the two or more reactive sites of the genipin molecule (see arrows below), its conjugates or its analogs as exemplified below using genipin and its dialdehyde form as examples.

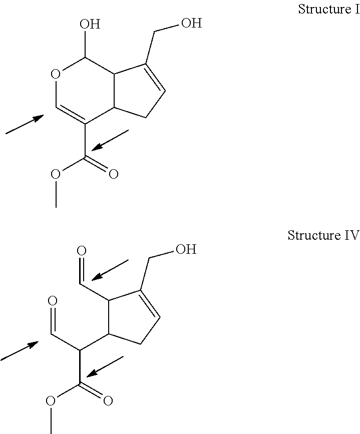 [SMILES: COC(=O)C1=COC(O)C2C(CO)=CCC12 ; COC(=O)C(C=O)C1CC=C(CO)C1C=O]

Reactions of primary amine group of the gelling agent at the ester carbonyl group is expected to form an amide linkage, while reactions of the primary amine group of another gelling molecule at the enolic carbon is expected to lead to insertion of nitrogen into the ring following several molecular rearrangements as shown in Structure IX, and described in Pujana, M. A., et al. Carbohydrate Polymers 94: 836-842 (2013), which is incorporated by reference as if fully set forth herein. On the other hand, the open chain form resulting from ring opening of hemiacetal structure of genipin, can form imine linkages as a result of reactions between primary amine groups of gellable agent polymeric molecules, and the aldehyde groups of genipin shown in Structure X. The wavy lines in Structure IX and Xtructure X represent polymer chains of gellable agent.

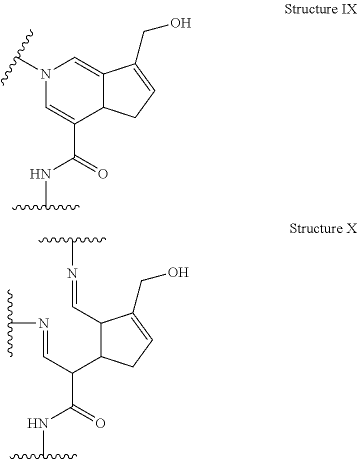

Crosslinked structures containing amide bonds and nitrogen-inserted ring structures are expected to be stable to temperatures over a wide pH range and expected to maintain gel viscosity for relatively long periods of time (e.g., indefinitely), making such gels suitable for sealing applications (e.g., blocking unwanted fluid flow into or out of formation). However, when the treatment fluid composition or downhole conditions favor ring open dialdehyde structure (Structure IV) for the crosslinker, the stability of the resulting gel network containing imine structures (as shown in Structure IX) may be shorter-lived ranging from few minutes (e.g., 30 minutes or more) to few days, depending on the temperature and pH (e.g., at higher temperatures and low pH fluids having a pH values less than 7). Such gelled fluids are expected to be suitable as treatment fluids in applications where retention of viscosities for short periods followed by loss of viscosity to form thin fluids. One example of such applications includes fracturing/gravel packing where viscosified fluids allow for carrying particulates to a desired location in wellbore or subterranean formation. Upon completion of the operation, the fluid can be flown back as a thin fluid. In such applications addition of breakers may be minimized or avoided. Another example of wellbore operation suitable for such fluids includes a temporary isolation packer, or a fluid diverting agent wherein gel stability may be needed for a short duration until a subsequent operation is performed on a different part of the wellbore, at the end of which the well is put back on production, and the reduced viscosity treatment fluid is flown out of the wellbore.

In some embodiments, the treatment fluids of the present invention may comprise one or more salts. Representative salts include the chloride, bromide, acetate, and formate salts of potassium, sodium, calcium, magnesium, zinc and ammonium ions.

In some embodiments, the treatment fluids of the present invention may comprise one or more acid catalysts. Representative acid catalysts include, but are not limited to, sulfonic acids (e.g., p-toluene sulfonic acid and methanesulfonic acid).

The aqueous base fluid used in the treatment fluids of the embodiments of the present invention comprises one or more aqueous fluids. For example, the aqueous base fluid may include, but is not limited to, seawater, produced water, flowback water, fresh water, saltwater (e.g., water containing one or more salts dissolved therein), brine (e.g., saturated saltwater), weighted brine (e.g., an aqueous solution of sodium bromide, calcium bromide, zinc bromide and the like), or any combination thereof. Generally, the aqueous fluid may be from any source, provided that it does not contain components that might adversely affect the stability and/or performance of the treatment fluids of the embodiments of the present invention. In certain embodiments, the density of the aqueous base fluid can be increased, among other purposes, to provide additional particle transport and suspension in the treatment fluids of the embodiments of the present invention. When the solubility of crosslinker (e.g., analogs of genipin) or catalyst in water is less than 5% by weight, water-miscible solvents such alcohols (e.g., isopropanol), alcohol ethers (e.g., ethylene glycol methyl ether, ethyeleneglycol butyl ether or combinations thereof) or ketones (e.g., acetone, methyl ethyl ketone or combinations thereof) may be added to the aqueous solution or the crosslinker, or the catalyst may be predissolved in the water-miscible solvent and added to the aqueous solution.

In certain embodiments, the pH of the aqueous base fluid may be adjusted (e.g., by a buffer or other pH adjusting agent) prior to the preparation of the treatment fluids to, among other things, further facilitate hydration of the gellable agent; to activate a crosslinking agent; to facilitate the reaction; to extend the gel time; to increase stability of the crosslinked gel; and/or to reduce the viscosity of the treatment fluid (e.g., activate a breaker, deactivate a crosslinking agent). The pH may be adjusted to a specific level, which may depend on, among other factors, the types of gellable agents, and/or crosslinking agents in the treatment fluid. In general, the pH of the fluid may be about 11 or less (e.g., from about 4.0 to about 8, from about 5.0 to about 9.5, from about 5.5 to about 9, from about 6 to about 10, from about 5 to about 10 or from about 7 to about 8) when a stable gelled fluid is desired. Suitable pH adjusting agents include any compounds capable of altering the pH of the treatment fluid. Examples of such compounds that may be used include, but are not limited to, formic acid, fumaric acid, acetic acid, acetic anhydride, sodium acetate, sodium diacetate, monosodium-, disodium- or trisodium salts of citric acid, potassium tartarates, borate salts, hydrochloric acid, sodium hydroxide, potassium hydroxide, lithium hydroxide, various carbonates, bicarbonates, phosphates, hydrogen phosphates, dihydrogen phosphates any combination thereof, or any other commonly used pH control agent that does not adversely react with the gellable agent or the crosslinking agent to prevent its use in accordance with the method of the present invention. When used, the pH-adjusting compound is generally present in a treatment concentrate of the present invention in an amount in the range of from about 0.5% to about 10% by weight of the aqueous fluid therein. In another embodiment, the pH-adjusting compound is generally present in a treatment fluid of the present invention in an amount in the range of from about 0.01% to about 0.3% by weight of the aqueous fluid therein. One of ordinary skill in the art, with the benefit of this disclosure, will recognize if/when such density and/or pH adjustments are appropriate.

The treatment fluids of the embodiments of the present invention comprise a suitable gellable agent. The gellable agent may be any suitable gellable agent that is capable of being crosslinked by the crosslinking agents described herein; and is compatible with the aqueous base fluid.

The gellable agent may be present in the treatment fluid in an amount in the range of from about 0.1 percent to about 15 percent by weight of the treatment fluid, e.g., from about 0.5 percent to about 5 percent by weight or from about 1 percent to about 3 percent by weight of the treatment fluid.

The crosslinking agent may be present in the treatment fluid in an amount in the range of from about 0.01 percent to about 1.5 percent by weight of the treatment fluid, e.g., 0.1 percent to about 0.5 percent by weight, from about 0.15 percent to about 0.35 percent by weight, from about 0.2 percent to about 0.3 percent by weight or from about 0.15 to about 0.3 percent by weight of the treatment fluid.

In some embodiments, the weight ratio of gellable agent to crosslinking agent is 1:0.01 to 1:0.5, alternately, 1:0.1 to 1:0.5, alternately 1:0.15 to 1:0.3.

In some embodiments, the treatment fluids of the present invention may comprise particulates, such as proppant particulates or gravel particulates. Particulates suitable for use in the present invention may comprise any material suitable for use in subterranean operations. Suitable materials for these particulates include, but are not limited to, sand, bauxite, ceramic materials, glass materials, polymer materials, Teflon® materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. The particulate size generally may range from about 2 mesh to about 400 mesh or smaller on the U.S. Sieve Series; however, in certain circumstances, other sizes may be desired and will be entirely suitable for practice of the present invention. In particular embodiments, preferred particulates size distribution ranges are one or more of 6/12, 8/16, 12/20, 16/30, 20/40, 30/50, 40/60, 40/70, or 50/70 mesh. Also, mixtures of particulates may be used having different particle size distribution ranges to enhance the packed volume of the proppant particulates within the fracture. It should be understood that the term “particulate,” as used in this disclosure, includes all known shapes of materials, including substantially spherical materials, fibrous materials, polygonal materials (such as cubic materials), and mixtures thereof. Moreover, fibrous materials, that may or may not be used to bear the pressure of a closed fracture, may be included in certain embodiments of the present invention. In certain embodiments, the particulates included in the treatment fluids of the present invention may be coated with any suitable resin or tackifying agent known to those of ordinary skill in the art. In certain embodiments, the particulates may be present in the treatment fluids of the present invention in an amount in the range of from about 0.5 pounds per gallon (“ppg”) to about 30 ppg by volume of the treatment fluid.

The treatment fluid of the embodiments of the present invention can also comprise a gel breaker which “breaks” or diminishes the viscosity of the fracturing fluid so that it is more easily recovered from the fracture during clean up. Examples of gel breakers suitable for use with the treatment fluids of the embodiments of the present invention include enzymes, acids, acid-generating compounds (e.g., polyesters), oxidizers (e.g., persulfate salts) and any combination thereof, with acids and acid generating compounds being the most preferred.

The treatment fluids of the embodiments of the present invention may include one or more of a variety of well-known additives which do not adversely react with the treatment fluids. Exemplary additives may include, but are not limited to, gel stabilizers (e.g., Gel-Sta™ from Halliburton), fluid loss control additives, acids, corrosion inhibitors, catalysts, clay stabilizers, biocides, bactericides, friction reducers, gas, surfactants, solubilizers, pH adjusting agents, and the like. For example, in some embodiments, it may be desired to foam a treatment fluid of the embodiments of the present invention using a gas, such as air, nitrogen, or carbon dioxide. Those of ordinary skill in the art, with the benefit of this disclosure, will be able to determine the appropriate additives for a particular application.

The treatment fluids of the embodiments of the present invention can be prepared by dissolving or suspending one or more of the components (e.g., a gellable agent and a crosslinking agent) in an aqueous fluid (e.g., fresh water and/or seawater); combining one or more of the components in solid form, then adding an aqueous fluid; or dissolving one or more of the components in water or water-miscible solvent and adding, to the solution, one or more of the components in solid form. Additional components may be added into the treatment fluid.

In an embodiment, a method of using the treatment fluid of the embodiments of the present invention comprises obtaining or providing a treatment fluid comprising a gellable agent and a crosslinking agent; and placing (e.g., injecting, pumping, flowing or combinations thereof) the treatment fluid in a subterranean formation. In some embodiments, the method further comprises crosslinking the gellable agent with the crosslinking agent. The treatment fluid of the embodiments of the present invention may be used for any treatment or subterranean operation known to one of ordinary skill in the art.

In an embodiment, a method of using the treatment fluid of the embodiments of the present invention comprises placing a treatment fluid comprising a gellable agent and a crosslinking agent in a subterranean formation. In some embodiments, the method further comprises crosslinking the gellable agent with the crosslinking agent.

In various embodiments, the present invention provides a system comprising a treatment fluid comprising: a gellable agent comprising at least two primary amino groups, and a crosslinking agent comprising genipin, its conjugates, derivatives, analogs, or combinations thereof; and a subterranean formation comprising the treatment fluid.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those of ordinary skill in the art, and that such modifications and variations are considered to be within the scope of this invention as defined by the appended claims.

### EXAMPLES

The present invention can be better understood by reference to the following examples which are offered by way of illustration. The present invention is not limited to the examples given herein.

### Example 1

Polyvinyl formamide (PVF; Lupamin™ 9030; 30% hydrolysis; molecular weight. 340,000; BASF) was diluted with water to obtain a 3 wt. % active polymer solution in water. Solid genipin (purchased from Aldrich-Sigma Chemical Company) was predissolved in water and mixed with PVF solutions to obtain aqueous mixtures, each containing the weight % amounts of genipin shown below in Table 1. The pH of the mixed solutions was 8.6. Crosslinking experiments were performed at 140° F. and 160° F. by monitoring viscosity changes as a function of time using a Brookfield Viscometer equipped with a #2 spindle stirring at 10 rpm. The results from the crosslinking experiments are shown in Table 1.

TABLE 1

| PVF | Genipin | KCl | Temperature | Gel time | |
|---|---|---|---|---|---|
| (wt. %) | (wt. %) | (wt. %) | (° F.) | (hours) | Gel stability |
| 3 | 0.3 | — | 140 | No gel | — |
| 3 | 0.3 | 2 | 140 | No gel | — |
| 3 | 0.15 | — | 160 | 6.7 | Stable |
| 3 | 0.15 | 2 | 160 | 8.9 | Stable |
| 3 | 0.3 | — | 160 | 7.2 | Stable |
| 3 | 0.3 | 2 | 160 | 7.5 | Stable |
| 3* | 0.3 | 2 | 160 | 7.3 | Stable |

*A small amount of p-toluene sulfonic acid was added.

The results show that at polymeric gelling agent/crosslinker ratios ranging from 1:0.05 to 1:0.1, stable dark-blue gels with gel times long enough to inject into a formation, thereby plugging fluid flow channels and controlling flow of undesirable fluids into or out of subterranean formation.

Repetition of the above experiment, with 1% by weight polymer solution containing genipin in the polymer to crosslinker weight ratio with or without 2% KCl did not gel at 140° F. or 160° F. in 48 hours and 24 hours at 140° F. and 160° F. respectively.

### Example 2

PVF (Lupamin™ 9095; 95% hydrolysis; Molecular weight, 340,000, BASF) was provided as a 1 wt. % active polymer solution in water. Aqueous solutions of genipin were provided and added to PVF solution such that, each mixture contained the weight % crosslinker amounts shown in Table 1. The pH of the mixed solutions was 9.6. Crosslinking experiments were performed at 140° F. and 160° F. with and without 2% KCl. No crosslinking was observed in 48 hours and 24 hours respectively at 140° F. and 160° F. even though solution color changed from colorless to dark blue with deposition of a small amount of precipitated solid.

### Example 3

Experiments identical to those described in Example 1 were performed with 3% polymer solutions of branched polyethyleneimine (molecular weight, 750,000) available from Halliburton Energy Services. The pH of the solutions was 10.1. No crossslinking was observed at 160° F. in 72 hours, even though the color of the solutions changed from colorless to brown color.

### Example 4

Solid chitosan was dissolved in 1% dilute acetic acid solution in water to obtain a 1% polymer solution. Solid genipin (10% by weight of the polymer) was added and dissolved with stirring. The pH of the mixture was 2.3. The mixture was allowed to crosslink in a Brookfield viscometer at 140° F. and 160° F. The solution crosslinked at 140° F., and the gel was stable at 140° F. for 3-6 hours before it completely broke down to a thin fluid. The mixture kept at 160° F. gelled, but broke down to a thin fluid in less than 30 minutes. A sample of the same mixture was kept at room temperature. The solution gelled to form deep blue crosslinked gel that was stable for at least one month.

In another set of experiments, 1% chitosan solutions were prepared in 2% acetic acid solution in water. The pH of the acidic solution was adjusted to a value of 5 by the addition of sodium acetate (approximately 9-10% by weight of the solution). Genepin was added in amounts of 10% by weight of chitosan, and the solutions were allowed to crosslink at 140° F. and 160° F. Both solutions gelled immediately at temperature to form stiff blue gels, and the gels were stable for at least 60 hours. These results indicate that the gel becomes more stable at pH values which are less acidic than unbuffered dilute acetic acid solutions.

In another set of experiments, a 1% chitosan solution in 2% acetic acid solution was diluted with water to prepare 0.25% chitosan solution in 0.5% acetic acid solution. The pH of the acid solution was raised to a pH value of 5 with the addition of suitable amount of sodium acetate. Genepin was added to the solution in amounts of 10% by weight of the polymer. The resulting mixture was allowed to crosslink at 140° F. and 160° F. The fluids crosslinked in about one hour, and the gels remained stable for at least 16 hours before they broke down to thin fluids.

### Example 5

In order to establish that primary amine groups are critical for the crosslinking reactions crosslinking reactions were performed under conditions described in Example 1, by replacing Lupamin with two traditional polysaccharides, namely guar gum and hydroxypropyl guar. The concentrations of polymers were 0.5% in water, and the amount of genipin was 10 weight % of the polymer weight. The pH of the fluids was between 5 to 6. The reactions were performed at 160° F. No viscosification due to crosslinking reactions was observed even though the solutions turned blue in color. This result suggests that amine groups, especially primary amine groups, may be needed for crosslinking reactions with genipin.

The results from the Examples may be interpreted in terms of formation of reaction products from the cyclic form and the ring-open form of the genipin core structure. The retention of ring structure containing extended conjugation after replacement of enolic ether oxygen in Structure I by nitrogen of primary amine containing polymers followed by complex molecular rearrangements of the genipin molecule, that may possibly include coupling of two molecules of newly formed ring-substituted products may explain the blue color formation in reactions with polysaccharides and synthetic polymers irrespective of whether they contain amine nitrogens or hydroxyl groups. However, only in the case of polymers containing primary amine groups additional coupling reactions may be taking place at the ester group forming amide groups leading to crosslinking reactions forming gels. In such cases, where the crosslinking takes place while retaining the cyclic structure of genipin core structure, stable crosslinked gels suitable for applications requiring long term gel stability, for example, for permanent blocking of fluid flow paths within a subterranean formation may be relevant.

In cases, where crosslinking takes place via dialdehyde form shown in Structure IV through formation of imine structures, in addition to amide bond formations, the reversibility of imine formation reactions under suitable conditions, particularly under acidic conditions in the presence excess water, gels can be designed to be stable for a desired duration and then breakdown to thin fluids by selecting fluid compositions with suitable pH profiles during the application duration. Such compositions are expected to be useful in fracturing applications, temporary chemical packer designs, and temporary fluid diversion applications. The pH profiles during duration of downhole applications may be adjusted by using pH adjusting compounds that slowly release acids (e.g., polyesters such as polylactic aicds or encapsulated organic acids) or base (e.g., slowly soluble basic compounds such as magnesium oxide, calcium oxide, or ammonia generating compounds such as urea, polyacrylamides or water-soluble organic amides such as acetamide).

The present invention provides for the following exemplary embodiments, the numbering of which is not to be construed as designating levels of importance:

Embodiment 1 relates to a method comprising: obtaining or providing a treatment fluid comprising a gellable agent comprising at least two primary amino groups, and a crosslinking agent comprising genipin, its conjugates, derivatives, analogs, or combinations thereof; and placing the treatment fluid in a subterranean formation.

Embodiment 2 relates to the method of Embodiment 1, further comprising crosslinking the gellable agent with the crosslinking agent.

Embodiment 3 relates to the method of Embodiments 1-2, wherein the treatment fluid comprises a drilling fluid, stimulation fluid, clean-up fluid, fracturing fluid, spotting fluid, production fluid, completion fluid, remedial treatment fluid, abandonment fluid, acidizing fluid, cementing fluid, a fluid control material, a packing fluid or combinations thereof.

Embodiment 4 relates to the method of Embodiments 1-3, wherein the crosslinked treatment fluid reduces the permeabily of a subterranean formation to the flow of fluids through a portion of a subterranean formation.

Embodiment 5 relates to the method of Embodiments 1-4, wherein the treatment fluid comprises water.

Embodiment 6 relates to the method of Embodiments 1-5, wherein the gellable agent comprises partially hydrolyzed polyvinylformamide, chitosan or combinations thereof.

Embodiment 7 relates to the method of Embodiments 1-6, wherein the treatment fluid has a viscosity that is sufficiently high for it to be used as a fluid control material.

Embodiment 8 relates to the method of Embodiments 1-7, wherein the treatment fluid has a pH of from about 5.0 to about 10.

Embodiment 9 relates to the method of Embodiments 1-8, wherein the crosslinking agent is a crosslinking agent represented by Structure I, II or III:

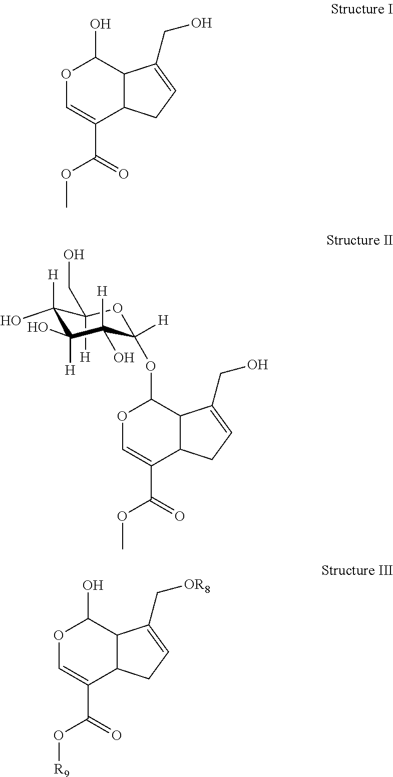

wherein R₈ and R₉ may be independently hydrogen, alkyl, cycloalkyl, heterocycloalkyl, alkenyl, aryl or acyl.

Embodiment 10 relates to the method of Embodiments 1-8, wherein the crosslinking agent is a crosslinking agent represented by Structure V:

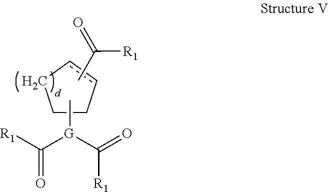

wherein:
G represents an alkyl, alkenyl, cycloalkyl, heterocyclyl or an aryl group;
each R₁ is, independently, hydrogen, —OR₂, —NR₃R₄ or a halogen, wherein each R₂, R₃, and R₄ are, independently, hydrogen, alkyl, cycloalkyl, cycloalkylalkyl, aryl, arylalkyl or an R₃ and an R₄, together with the nitrogen atom to which they are attached, form a heterocyclyl group;
the dashed bond represents an optional double bond;
the subscript d is an integer from 1 to 3; and
one or more carbon atoms not bearing a C(O)R₁ group or G may be optionally substituted.

Embodiment 11 relates to the method of Embodiment 10, wherein G represents an alkyl group comprising 1 to 8 carbon atoms.

Embodiment 12 relates to the method of Embodiment 10-11, wherein at least one R₁ is hydrogen.

Embodiment 13 relates to the method of Embodiments 10-12, wherein two R₁ groups are hydrogen and one R₁ group is hydrogen, —OR₂, —NR₃R₄ or a halogen.

Embodiment 14 relates to the method of Embodiments 10-13, wherein one R₁ group is hydrogen and the other two R₁ groups are independently hydrogen, —OR₂, —NR₃R₄ or a halogen.

Embodiment 15 relates to the method of Embodiments 10-14, wherein two R₁ groups are hydrogen and the other R₁ group is —OR₂.

Embodiment 16 relates to the method of Embodiment 15, wherein R₂ is alkyl.

Embodiment 17 relates to the method of Embodiments 1-8, wherein the crosslinking agent is a crosslinking agent represented by Structure VI:

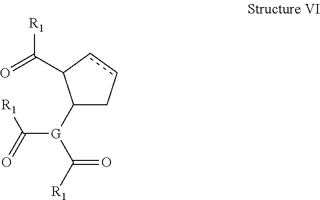

wherein:
G represents an alkyl, alkenyl, cycloalkyl, heterocyclyl or an aryl group;
the dashed bond represents an optional double bond;
each R₁ is, independently, hydrogen, —OR₂, —NR₃R₄ or a halogen, wherein each R₂, R₃, and R₄ are, independently, hydrogen, alkyl, cycloalkyl, cycloalkylalkyl, aryl, arylalkyl or an R₃ and an R₄, together with the nitrogen atom to which they are attached, form a heterocyclyl group; and
wherein one or more carbon atoms not bearing a C(O)R₁ group or G-(C(O)R₁)₂ may be optionally substituted.

Embodiment 18 relates to the method of Embodiment 17, wherein G represents an alkyl group comprising 1 to 8 carbon atoms.

Embodiment 19 relates to the method of Embodiments 17 or 18, wherein at least one R₁ is hydrogen.

Embodiment 20 relates to the method of Embodiments 17-19, wherein two R₁ groups are hydrogen and one R₁ group is hydrogen, —OR₂, —NR₃R₄ or a halogen.

Embodiment 21 relates to the method of Embodiments 17-20, wherein one R₁ group is hydrogen and the other two R₁ groups are independently hydrogen, —OR₂, —NR₃R₄ or a halogen.

Embodiment 22 relates to the method of Embodiments 17-21, wherein two R₁ groups are hydrogen and the other R₁ group is —OR₂.

Embodiment 23 relates to the method of Embodiment 22, wherein R₂ is alkyl.

Embodiment 24 relates to the method of Embodiments 17-23, wherein one or more carbon atoms not bearing a C(O)R₁ group or a G-(C(O)R₁)₂ group are substituted with one or more groups G′-R₅, wherein each G′ independently represents an alkyl, alkenyl, cycloalkyl, heterocyclyl or an aryl group and each R₅ independently represents hydrogen, —OR₆ or —NR₃R₄, wherein R₆ is hydrogen or alkyl.

Embodiment 25 relates to the method of Embodiment 24, wherein the crosslinking agent represented by Structure VI has one G′-R₅ group, wherein G′-R₅ represents G′-OR₆, wherein G′ represents an alkyl group comprising 1 to 8 carbon atoms.

Embodiment 26 relates to the method of Embodiment 27, wherein R₆ is hydrogen or alkyl.

Embodiment 27 relates to the method of Embodiment 26, wherein R₆ is hydrogen.

Embodiment 28 relates to the method of Embodiments 1-8, wherein the crosslinking agent is a crosslinking agent represented by Structure VII:

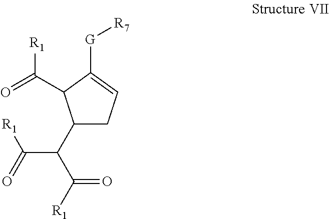

wherein:
G represents an alkyl, alkenyl, cycloalkyl, heterocyclyl or an aryl group;
each R₁ is, independently, hydrogen, —OR₂, —NR₃R₄ or a halogen, wherein each R₂, R₃, and R₄ are, independently, hydrogen, alkyl, cycloalkyl, cycloalkylalkyl, aryl, arylalkyl or an R₃ and an R₄, together with the nitrogen atom to which they are attached, form a heterocyclyl group; and
R₇ represents —OR₆, wherein R₆ is hydrogen or alkyl.

Embodiment 29 relates to the method of Embodiment 28, wherein G represents an alkyl group comprising 1 to 8 carbon atoms.

Embodiment 30 relates to the method of Embodiment 28-29, wherein at least one R₁ is hydrogen.

Embodiment 31 relates to the method of Embodiments 28-30, wherein two R₁ groups are hydrogen and one R₁ group is hydrogen, —OR₂, —NR₃R₄ or a halogen.

Embodiment 32 relates to the method of Embodiments 28-31, wherein one R₁ group is hydrogen and the other two R₁ groups are independently hydrogen, —OR₂, —NR₃R₄ or a halogen.

Embodiment 33 relates to the method of Embodiments 28-32, wherein two R₁ groups are hydrogen and the other R₁ group is —OR₂.

Embodiment 34 relates to the method of Embodiment 33, wherein R₂ is hydrogen or alkyl.

Embodiment 35 relates to the method of Embodiment 34, wherein R₂ is alkyl.

Embodiment 36 relates to the method of Embodiments 28-35, wherein G represents an alkyl group comprising 1 to 4 carbon atoms and R₇ represents —OR₆, wherein R₆ is hydrogen or alkyl.

Embodiment 37 relates to the method of Embodiments 1-8, wherein the crosslinking agent is a crosslinking agent represented by Structure VIII:

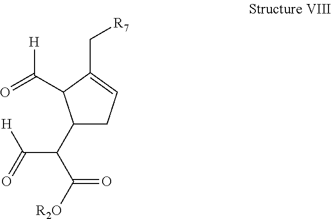

wherein R₂ is alkyl; and R₇ is —OR₆, wherein R₆ is hydrogen or alkyl.

Embodiment 38 relates to the method of Embodiment 37, wherein R₂ is methyl and R₆ represents OH.

Embodiment 39 relates to a method comprising: placing a treatment fluid comprising a gellable agent comprising at least two primary groups, and comprising genipin, its conjugates, derivatives, analogs, or combinations thereof, in a subterranean formation.

Embodiment 40 relates to the method of Embodiment 39, further comprising crosslinking the gellable agent with the crosslinking agent.

Embodiment 41 relates to a composition comprising: a gellable agent comprising partially hydrolyzed polyvinylformamide, chitosan or combinations thereof; and a crosslinking agent represented by Structure VII:

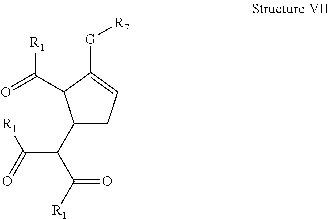

wherein:
G represents an alkyl, alkenyl, cycloalkyl, heterocyclyl or an aryl group;
each R₁ is, independently, hydrogen, —OR₂, —NR₃R₄ or a halogen, wherein each R₂, R₃, and R₄ are, independently, hydrogen, alkyl, cycloalkyl, cycloalkylalkyl, aryl, arylalkyl or an R₃ and an R₄, together with the nitrogen atom to which they are attached, form a heterocyclyl group; and
R₇ represents —OR₆, wherein R₆ is hydrogen or alkyl.

Embodiment 42 relates to the composition of Embodiment 41, wherein the composition comprises crosslinked gellable agent, crosslinked via the crosslinking agent.

Embodiment 43 relates to a system comprising: a treatment fluid comprising a gellable agent comprising at least two primary amino groups, and a crosslinking agent comprising genipin, its conjugates, derivatives, analogs, or combinations thereof; and a subterranean formation comprising the treatment fluid.

What is claimed is:

1. A method comprising:
obtaining or providing a treatment fluid comprising:
a gellable agent comprising at least two primary amino groups, and
a crosslinking agent comprising genipin, its conjugates, derivatives, analogs, or combinations thereof; and
placing the treatment fluid in a subterranean formation.

2. The method of claim 1, further comprising crosslinking the gellable agent with the crosslinking agent.

3. The method of claim 1, wherein the treatment fluid comprises a drilling fluid, stimulation fluid, clean-up fluid, fracturing fluid, spotting fluid, production fluid, completion fluid, remedial treatment fluid, abandonment fluid, acidizing fluid, cementing fluid, a fluid control material, a packing fluid or combinations thereof.

4. The method of claim 1, wherein the crosslinked treatment fluid reduces the permeabily of a subterranean formation to the flow of fluids through a portion of a subterranean formation.

5. The method of claim 4, wherein the treatment fluid comprises water.

6. The method of claim 1, wherein the gellable agent comprises partially hydrolyzed polyvinylformamide, chitosan or combinations thereof.

7. The method of claim 1, wherein the treatment fluid has a viscosity that is sufficiently high for it to be used as a fluid control material.

8. The method of claim 1, wherein the treatment fluid has a pH of from about 5.0 to about 10.

9. The method of claim 1, wherein the crosslinking agent is a crosslinking agent represented by Structure I, II or III: 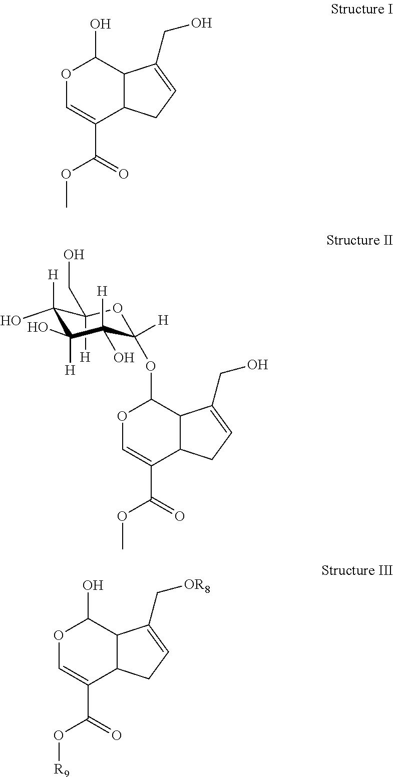
wherein R₈ and R₉ may be independently hydrogen, alkyl, cycloalkyl, heterocycloalkyl, alkenyl, aryl or acyl.

10. The method of claim 1, wherein the crosslinking agent is a crosslinking agent represented by Structure V: 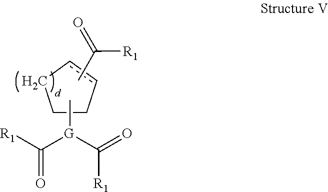
wherein:
G represents an alkyl, alkenyl, cycloalkyl, heterocyclyl or an aryl group;
each R₁ is, independently, hydrogen, —OR₂, —NR₃R₄ or a halogen, wherein each R₂, R₃, and R₄ are, independently, hydrogen, alkyl, cycloalkyl, cycloalkylalkyl, aryl, arylalkyl or an R₃ and an R₄, together with the nitrogen atom to which they are attached, form a heterocyclyl group;
the dashed bond represents an optional double bond;
the subscript d is an integer from 1 to 3; and
one or more carbon atoms not bearing a C(O)R₁ group or G may be optionally substituted.

11. The method of claim 10, wherein G represents an alkyl group comprising 1 to 8 carbon atoms.

12. The method of claim 10, wherein at least one R₁ is hydrogen.

13. The method of claim 10, wherein two R₁ groups are hydrogen and one R₁ group is hydrogen, —OR₂, —NR₃R₄ or a halogen.

14. The method of claim 10, wherein one R₁ group is hydrogen and the other two R₁ groups are independently hydrogen, —OR₂, —NR₃R₄ or a halogen.

15. The method of claim 10, wherein two R₁ groups are hydrogen and the other R₁ group is —OR₂.

16. The method of claim 15, wherein R₂ is alkyl.

17. The method of claim 1, wherein the crosslinking agent is a crosslinking agent represented by Structure VI: 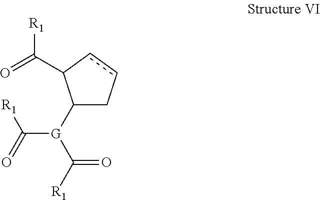
wherein:
G represents an alkyl, alkenyl, cycloalkyl, heterocyclyl or an aryl group;
the dashed bond represents an optional double bond;
each R₁ is, independently, hydrogen, —OR₂, —NR₃R₄ or a halogen, wherein each R₂, R₃, and R₄ are, independently, hydrogen, alkyl, cycloalkyl, cycloalkylalkyl, aryl, arylalkyl or an R₃ and an R₄, together with the nitrogen atom to which they are attached, form a heterocyclyl group; and
wherein one or more carbon atoms not bearing a C(O)R₁ group or G-(C(O)R₁)₂ may be optionally substituted.

18. The method of claim 17, wherein G represents an alkyl group comprising 1 to 8 carbon atoms.

19. The method of claim 17, wherein at least one R₁ is hydrogen.

20. The method of claim 17, wherein two R₁ groups are hydrogen and one R₁ group is hydrogen, —OR₂, —NR₃R₄ or a halogen.

21. The method of claim 17, wherein one R₁ group is hydrogen and the other two R₁ groups are independently hydrogen, —OR₂, —NR₃R₄ or a halogen.

22. The method of claim 17, wherein two R₁ groups are hydrogen and the other R₁ group is —OR₂.

23. The method of claim 22, wherein R₂ is alkyl.

24. The method of claim 17, wherein one or more carbon atoms not bearing a C(O)R₁ group or a G-(C(O)R₁)₂ group are substituted with one or more groups G′-R₅, wherein each G′ independently represents an alkyl, alkenyl, cycloalkyl, heterocyclyl or an aryl group and each R₅ independently represents hydrogen, —OR₆ or —NR₃R₄, wherein R₆ is hydrogen or alkyl.

25. The method of claim 24, wherein the crosslinking agent represented by Structure VI has one G′-R₅ group, wherein G′-R₅ represents G′-OR₆, wherein G′ represents an alkyl group comprising 1 to 8 carbon atoms.

26. The method of claim 25, wherein R₆ is hydrogen or alkyl.

27. The method of claim 26, wherein R₆ is hydrogen.

28. The method of claim 1, wherein the crosslinking agent is a crosslinking agent represented by Structure VII: 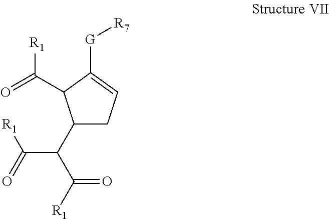
wherein:
G represents an alkyl, alkenyl, cycloalkyl, heterocyclyl or an aryl group;
each R₁ is, independently, hydrogen, —OR₂, —NR₃R₄ or a halogen, wherein each R₂, R₃, and R₄ are, independently, hydrogen, alkyl, cycloalkyl, cycloalkylalkyl, aryl, arylalkyl or an R₃ and an R₄, together with the nitrogen atom to which they are attached, form a heterocyclyl group; and
R₇ represents —OR₆, wherein R₆ is hydrogen or alkyl.

29. The method of claim 28, wherein G represents an alkyl group comprising 1 to 8 carbon atoms.

30. The method of claim 28, wherein at least one R₁ is hydrogen.

31. The method of claim 28, wherein two R₁ groups are hydrogen and one R₁ group is hydrogen, —OR₂, —NR₃R₄ or a halogen.

32. The method of claim 28, wherein one R₁ group is hydrogen and the other two R₁ groups are independently hydrogen, —OR₂, —NR₃R₄ or a halogen.

33. The method of claim 28, wherein two R₁ groups are hydrogen and the other R₁ group is —OR₂.

34. The method of claim 33, wherein R₂ is hydrogen or alkyl.

35. The method of claim 34, wherein R₂ is alkyl.

36. The method of claim 28, wherein G represents an alkyl group comprising 1 to 4 carbon atoms and R₇ represents —OR₆, wherein R₆ is hydrogen or alkyl.

37. The method of claim 1, wherein the crosslinking agent is a crosslinking agent represented by Structure VIII: 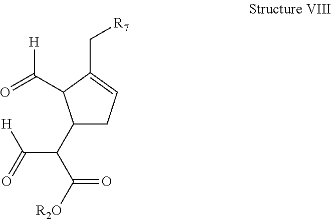
wherein R₂ is alkyl; and R₇ is —OR₆, wherein R₆ is hydrogen or alkyl.

38. The method of claim 37, wherein R₂ is methyl and R₆ represents OH.

39. A method comprising:
placing a treatment fluid comprising:
a gellable agent comprising at least two primary groups, and
comprising genipin, its conjugates, derivatives, analogs, or combinations thereof,
in a subterranean formation.

40. The method of claim 39, further comprising crosslinking the gellable agent with the crosslinking agent.

41. A composition comprising:
a gellable agent comprising partially hydrolyzed polyvinylformamide, chitosan or combinations thereof; and
a crosslinking agent represented by Structure VII: 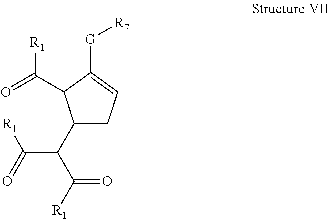
wherein:
G represents an alkyl, alkenyl, cycloalkyl, heterocyclyl or an aryl group;
each R₁ is, independently, hydrogen, —OR₂, —NR₃R₄ or a halogen, wherein each R₂, R₃, and R₄ are, independently, hydrogen, alkyl, cycloalkyl, cycloalkylalkyl, aryl, arylalkyl or an R₃ and an R₄, together with the nitrogen atom to which they are attached, form a heterocyclyl group; and
R₇ represents —OR₆, wherein R₆ is hydrogen or alkyl.

42. The composition of claim 41, wherein the composition comprises crosslinked gellable agent, crosslinked via the crosslinking agent.

43. A system comprising:
a treatment fluid comprising:
a gellable agent comprising at least two primary amino groups, and
a crosslinking agent comprising genipin, its conjugates, derivatives, analogs, or combinations thereof; and
a subterranean formation comprising the treatment fluid.
